(19) United States
(12) Patent Application Publication
(10) Pub. No.: US 2020/0365075 A1
(43) Pub. Date: Nov. 19, 2020

(54) DISPLAY SCREEN HAVING LIGHT-EMITTING DIODES

(71) Applicant: Aledia, Grenoble (FR)

(72) Inventors: Matthieu Charbonnier, Fontaine (FR); Frédéric Mercier, Saint Nicolas De Macherin (FR)

(73) Assignee: Aledia, Grenoble (FR)

(21) Appl. No.: 16/766,636

(22) PCT Filed: Dec. 6, 2018
(86) PCT No.: PCT/EP2018/083891

§ 371 Date: May 22, 2020

(30) Foreign Application Priority Data
Dec. 28, 2017 (FR) 1763313

(51) Int. Cl. G09G 3/32

(52) U.S. Cl. CPC G09G 3/32; G09G 2300/0861; G09G 2320/064

(57) ABSTRACT

A display screen including display circuits, each display circuit including a light-emitting diode, a controllable current source powering the light-emitting diode, and a control circuit capable of supplying a pulse-width modulated signal for controlling the current source from a periodic signal. The display screen further includes first electrodes coupled to the control circuits, a circuit for supplying a selection signal successively on each first electrode, and an oscillating circuit or oscillating circuits capable of supplying the periodic signals, the periodic signals being non-synchronous with the display circuit selection signals.

The present patent application claims the priority benefit of French patent application FR17/63313 which is herein incorporated by reference.

### BACKGROUND

The present disclosure relates to a display screen having its display pixels comprising light-emitting diodes, whatever their type of technology (2D, 3D light-emitting diode, organic light-emitting diode, etc.).

### DISCUSSION OF THE RELATED ART

The display pixels of a display screen comprising light-emitting diodes may comprise, for each display pixel, a circuit for controlling the light-emitting diode or the light-emitting diodes of the display pixel.

It is known to control a light-emitting diode by pulse-width modulation, also called PWM. This type of control comprises conducting successive constant current pulses through the light-emitting diode, the pulses being cyclically repeated, the duty cycle determining the light intensity emitted by the light-emitting diode. Such a control advantageously enables to operate the light-emitting diode at its optimum operating point where the efficiency of the light-emitting diode, equal to the ratio of the light power emitted by the light-emitting diode to the electric power consumed by the light-emitting diode, is maximum.

The current tendency is to decrease the dimensions of the display pixels of display screens comprising light-emitting diodes. This causes a decrease in the space available to form the display pixel control circuits. A disadvantage is that control circuits implementing a pulse-width modulation generally occupy more space than other types of control circuits.

### SUMMARY

An object of an embodiment is to provide a display screen comprising light-emitting diodes overcoming all or part of the disadvantages of existing display screens comprising light-emitting diodes.

Another object of an embodiment is for the control circuits of the display screen to implement a pulse-width modulation.

Another object of an embodiment is for the display pixels to have dimensions smaller than 200 μm.

Thus, an embodiment provides a display screen comprising display circuits, each display circuit comprising a light-emitting diode, a controllable current source powering the light-emitting diode, and a control circuit capable of supplying a pulse-width modulated signal for controlling the current source from a periodic signal, the display screen further comprising first electrodes coupled to the control circuits, a circuit for supplying a selecting signal successively on each first electrode, and an oscillating circuit or oscillating circuits capable of supplying the periodic signals, the periodic signals being non-synchronous with the display circuit selection signals.

According to an embodiment, the display screen comprises at least two oscillating circuits capable of supplying the periodic signals.

According to an embodiment, the at least two oscillating circuits are capable of supplying the non-synchronous periodic signals.

According to an embodiment, each of said at least two oscillating circuits is coupled to at least two of said control circuits.

According to an embodiment, each of said at least two oscillating circuits is coupled to at least ten of said control circuits.

According to an embodiment, the screen comprises at least one thousand display circuits and each of said at least two oscillating circuits is coupled to less than one hundred of said control circuits.

According to an embodiment, the screen further comprises second electrodes coupled to the control circuits and a circuit for supplying data signals on the second electrodes and the circuit for controlling each display circuit comprises a circuit for storing the data signal received by the control circuit and a circuit for comparing the data signal and the periodic signal capable of supplying the pulse-width modulated control signal.

According to an embodiment, the frequency of each periodic signal is greater than twice the frequency of the selection signal on one of the first electrodes.

According to an embodiment, the frequency of each periodic signal is greater than ten times the frequency of the selection signal on one of the first electrodes.

According to an embodiment, the frequency of each periodic signal is smaller than 1 MHz.

### BRIEF DESCRIPTION OF THE DRAWINGS

The foregoing and other features and advantages will be discussed in detail in the following non-limiting description of specific embodiments in connection with the accompanying drawings, among which:

FIG. 1 partially and schematically shows an embodiment of a display screen;

FIG. 2 shows a more detailed embodiment of a portion of the display screen of FIG. 1;

FIG. 3 shows an embodiment of an oscillating circuit and of a display circuit of the display screen of FIG. 1;

FIG. 4 shows a timing diagram of signals obtained during the operation of the oscillating circuit and of the display circuit shown in FIG. 3;

FIGS. 5 and 6 show other embodiments of the oscillating circuit of FIG. 2; and

FIGS. 7 and 8 show other embodiments of the current source of the display circuit of FIG. 2.

### DETAILED DESCRIPTION

The same elements have been designated with the same reference numerals in the various drawings and, further, the various drawings are not to scale. For clarity, only those steps and elements which are useful to the understanding of the described embodiments have been shown and are detailed. The terms “approximately”, “substantially”, “about”, and “in the order of” are used herein to designate a tolerance of plus or minus 10%, preferably of plus or minus 5%, of the value in question.

Further, a signal which alternates between a first constant state, for example, a low state, noted “0”, and a second constant state, for example, a high state, noted “1”, is called a “binary signal”. The high and low states of different binary signals of a same electronic circuit may be different. In particular, the binary signals may correspond to voltages or to currents which may not be perfectly constant in the high or low state. Further, in the following description, the source and the drain of a MOS transistor are called “power terminals” of the insulated gate field-effect transistor, or MOS transistor. Further, in the present description, the term “coupled” or “linked” will be used to designate either a direct electric connection (then meaning “connected”) or a connection via one or a plurality of intermediate components (resistor, capacitor, etc.). Further, a first binary signal is called “synchronous” with a second binary signal when the rising and/or falling edges of the first signal occur at the same time as the rising and/or falling edges of the second signal or occur at regular intervals with respect to the rising and/or falling edges of the second signal. In particular, synchronous binary signals derive from a common clock. Conversely, first and second binary signals are called “asynchronous” or “non-synchronous” when the rising and/or falling edges of the first signal occur neither at the same time as the rising and/or falling edges of the second signal nor at regular intervals with respect to the rising and/or falling edges of the second signal. In particular, asynchronous binary signals do not derive from a same clock.

A pixel of an image corresponds to the unit element of the image displayed by a display screen. When the display screen is a color image display screen, it generally comprises, for the display of each image pixel, at least three emission and/or light intensity regulation components, also called display sub-pixels, which each emit a light radiation substantially in a single color (for example, red, green, or blue). The superposition of the radiations emitted by the three display sub-pixels provides the observer with the colored sensation corresponding to the pixel of the displayed image. When the display screen is a monochrome image display screen, the display screen generally comprises a single light source for the display of each pixel of the image.

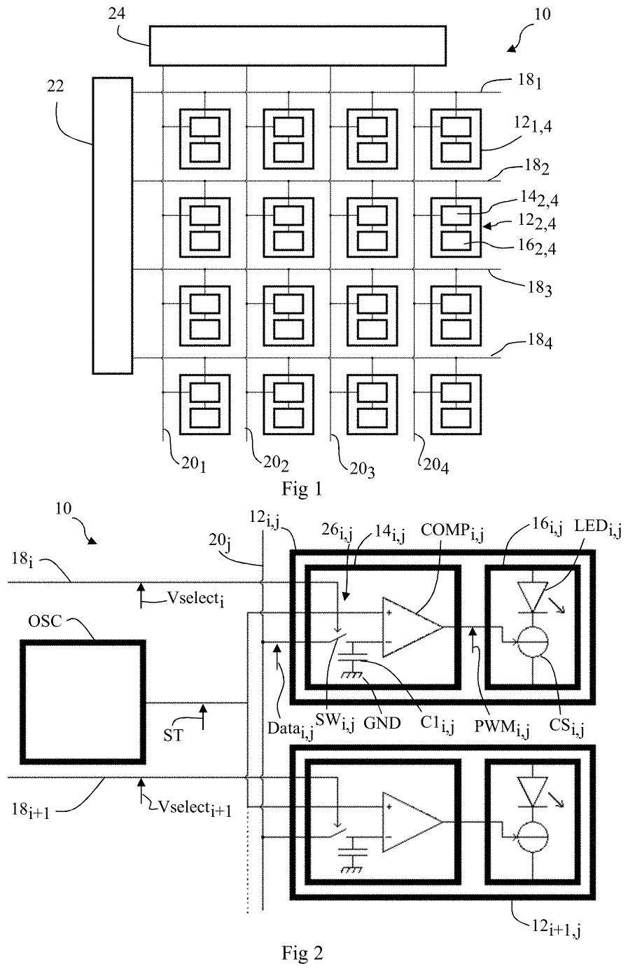

FIG. 1 partially and schematically shows an embodiment of a display screen 10. Display screen 10 comprises display circuits 12_{i,j} for example arranged in M rows and in N columns, M being an integer varying from 1 to 16,000 and N being an integer varying from 1 to 8,000, i being an integer varying from 1 to M and j being an integer varying from 1 to N. As an example, in FIG. 1, M and N are equal to 4. Each display circuit 12_{i,j} comprises a control circuit 14_{i,j} and a display sub-pixel 16_{i,j}. Each display sub-pixel 16_{i,j} comprises at least one light-emitting diode, not shown.

For each row, the control circuits 14_{i,j} of the display circuits 12_{i,j} in the row are coupled to a row electrode 18ᵢ. For each column, the control circuits 14_{i,j} of the display circuits 12_{i,j} of the column are coupled to a column electrode 20ⱼ.

Display screen 10 comprises a selection circuit 22 coupled to row electrodes 18ᵢ and capable of supplying a selection signal VSelectᵢ on each row electrode 18ᵢ. Display screen 10 comprises a control circuit 24 coupled to column electrodes 20ⱼ and capable of supplying a data signal Data_{i,j} on each column electrode 20ⱼ.

FIG. 2 shows a more detailed embodiment of two display circuits 12_{i,j} and 12_{i+1,j} of display screen 10.

According to an embodiment, display screen 10 comprises an oscillating circuit OSC for supplying an oscillating and periodic signal ST coupled to display circuits 12_{i,j} and 12_{i+1,j}. Each display sub-pixel 16_{i,j} comprises a light-emitting diode LED_{i,j} series-coupled to a controllable current source CS_{i,j}. Each control circuit 14_{i,j} comprises a storage circuit 26_{i,j} coupled to row electrode 18ᵢ and to column electrode 20ⱼ. Storage circuit 26_{i,j} is controlled by signal VSelectᵢ supplied by row electrode 18ᵢ and is capable of storing the signal Data_{i,j} supplied by column electrode 20ⱼ. According to an embodiment, storage circuit 26_{i,j} comprises a switch SW_{i,j} controlled by signal VSelectᵢ and a capacitor C1_{i,j}. The first terminal of switch SW_{i,j} is coupled to column electrode 20ⱼ and the second terminal of switch SW_{i,j} is coupled to the first electrode of capacitor C1_{i,j}, the second electrode of capacitor C1_{i,j} being coupled to a source GND of a low reference potential, for example, the ground. Each control circuit 14_{i,j} further comprises a comparison circuit COMP_{i,j} coupled at a first input (+) to oscillating circuit OSC and coupled at a second input (−) to the first electrode of capacitor C1_{i,j}. Comparison circuit COMP_{i,j} supplies a signal PWM_{i,j} for controlling current source CS_{i,j}.

An embodiment of an operating method of display screen 10 will now be described. Signal Vselectᵢ is a binary signal. When signal Vselectᵢ is in a first state, for example the low state, switch SW_{i,j} is off and when signal Vselectᵢ is in a second state, for example, the high state, switch SW_{i,j} is on. Signals Data_{i,j} are analog signals representative of the desired light intensities to be emitted by light-emitting diodes LED_{i,j}. When switch SW_{i,j} is turned on, the voltage across capacitor C1_{i,j} becomes substantially equal to signal Data_{i,j}. Signal PWM_{i,j} is a binary signal which depends on the comparison between signal ST and the voltage across capacitor C1_{i,j}, that is, signal Data_{i,j}. As an example, signal PWM_{i,j} is in a first state, for example, the high state, when signal ST is greater than signal Data_{i,j} and signal PWM_{i,j} is in a second state, for example, the low state, when signal ST is smaller than signal Data_{i,j}. Preferably, signal ST is a periodic signal which, over each period, continuously increases or continuously decreases substantially over the entire period. As an example, signal ST is a sawtooth signal which, over each period, increases or decreases with a substantially constant slope. The obtained signal PWM_{i,j} then is a pulse-width modulated cyclic signal, the duration of signal PWM_{i,j} in the high state over one cycle being proportional to signal Data_{i,j}.

Current source CS_{i,j} is controlled by signal PWM_{i,j}. As an example, current source CS_{i,j} is activated, that is, it powers light-emitting diode LED_{i,j} with current, when signal PWM_{i,j} is in the first state, for example, the high state, and current source CS_{i,j} is deactivated, that is, light-emitting diode LED_{i,j} is not crossed by a current, when signal PWM_{i,j} is in the second state, for example, the low state. When it is activated, the current supplied by current source CS_{i,j} is preferably substantially constant and equal to the current for which the efficiency of the light-emitting diode LED_{i,j} is maximum. Light-emitting diode LED_{i,j} is thus either powered at constant current or turned off. A control of light-emitting diode LED_{i,j} by pulse-width modulation is thus obtained.

In the embodiment illustrated in FIG. 2, oscillating circuit OSC is as an example coupled to two display circuits 12_{i,j} and 12_{i+1,j}. Generally, display screen 10 may comprise one or a plurality of oscillating circuits OSC, each oscillating circuit OSC being coupled to a number K of display circuits 12_{i,j}, K being an integer in the range from 1 to N*M, preferably varying from 1 to 8,000*4,000. The case where K is equal to 1 corresponds to the case where display screen 10 comprises an oscillating circuit OSC for each display circuit 12_{i,j} and the case where K is equal to N*M corresponds to the case where display screen 10 comprises a single oscillating circuit OSC for all the display circuits 12_{i,j}.

According to an embodiment, the rows of display sub-pixels are successively activated. Signals Vselectᵢ to VSelect_{M} are then successively set to the high state for a duration ΔT, signals Vselect₁ to VSelectᵢ₋₁ and Vselectᵢ₊₁ to VSelect_{M} being in the low state when signal Vselectᵢ is in the high state. Call F the display screen refreshment frequency. Frequency F is equal to 1/ΔT. As an example, frequency F varies from 25 Hz to 120 Hz. Frequency F′ of signal ST is greater than 2 times frequency F, preferably greater than 10 times frequency F, more preferably greater than 100 times frequency F. As an example, frequency F′ is greater than 1 kHz, preferably greater than 10 kHz, more preferably greater than 100 kHz. Frequency F′ of signal ST is preferably smaller than 1 MHz. Advantageously, the structure of oscillating circuit OSC may then be simple. Further, when oscillating circuit OSC uses switches, the losses due to the switchings of the switches are low.

According to an embodiment, signal ST is not synchronous with respect to signals VSelectᵢ and Data_{i,j}. This means that the beginning of each period of signal ST is not synchronous with the times at which signals Vselectᵢ switch state. Further, when a plurality of oscillating circuits OSC are present, the signals ST supplied by oscillating circuits OSC are preferably not synchronous. The design of display screen 10 is then simplified since signals ST do not have to be maintained synchronous with one another and with signals VSelectᵢ and Data_{i,j}. Further, current inrushes during the operation of display screen 10 are advantageously spread over time.

Further, the number of conductive tracks coupling oscillating circuit OSC and each associated control circuit 14_{i,j} is decreased. Further, when display screen 10 comprises a plurality of oscillating circuits OSC, the distance traveled by signal ST between each oscillating circuit OSC and the display circuits 12_{i,j} to which oscillating circuit OSC is coupled can be decreased with respect to the case where a clock signal should be supplied to each display circuit 12_{i,j}.

The display sub-pixels 16_{i,j} may be formed on a first electronic circuit and the control circuits 14_{i,j} and oscillating circuit OSC or oscillating circuits OSC may be formed on a second electronic circuit, the first and second electronic circuits being attached to each other. Control circuits 14_{i,j} and oscillating circuit OSC or oscillating circuits OSC may be formed according to a CMOS technology. As a variation, control circuits 14_{i,j} and oscillating circuit OSC or oscillating circuits OSC may be formed with thin-layer transistors.

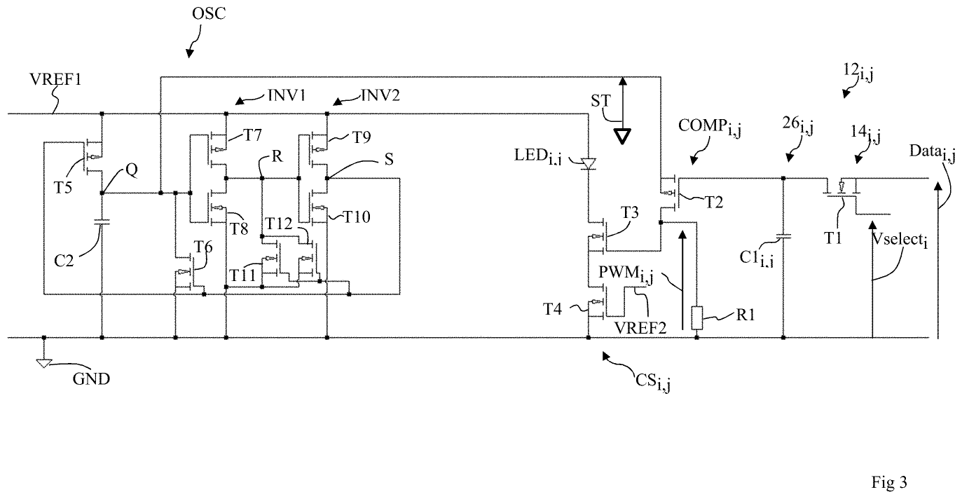

FIG. 3 shows an embodiment of an oscillating circuit OSC and of a display circuit 12_{i,j} of display screen 10 of FIG. 1.

In the present embodiment, switch SW_{i,j} of storage circuit 26_{i,j} of control circuit 14_{i,j} corresponds to a MOS transistor T1, for example, with an N channel, having its gate receiving signal Vselectᵢ, having its first power terminal receiving signal Data_{i,j} and having its second power terminal coupled to a first electrode of capacitor C1_{i,j}.

In the present embodiment, comparison circuit COMP_{i,j} comprises a MOS transistor T2, for example, with a P channel, having its gate coupled to the first electrode of capacitor C1_{i,j}, having its first power terminal receiving signal ST and having its second power terminal coupled to source GND of the low reference potential via a resistor R1. Signal PWM_{i,j} supplied by comparison circuit COMP_{i,j} corresponds to the voltage at the second power terminal of transistor T2.

In the present embodiment, controllable current source CS_{i,j} comprises two series-connected MOS transistors T3 and T4, for example, with an N channel. The gate of transistor T3 is coupled to the second power terminal of transistor T2. The first power terminal of transistor T3 is coupled to the cathode of light-emitting diode LED_{i,j} and the second power terminal of transistor T3 is coupled to the first power terminal of transistor T4. The gate of transistor T3 receives signal PWM_{i,j}. The anode of light-emitting diode LED_{i,j} is coupled to a source VREF1 of a first high reference potential, for example, the power supply voltage of display screen 10. The gate of transistor T4 is coupled to a source VREF2 of a second high reference potential. The second power terminal of transistor T4 is coupled to source GND of the low reference potential.

In this embodiment, the controllable current source created by transistors T4 and T3 is designed to draw a current from the cathode of the LED to ground GND, the anode of the LED being connected to high power supply potential VREF1. This structure is particularly adapted to a LED technology where the equivalent electric representation of the pixels would be a common-anode structure. It will be within the abilities of those skilled in the art to easily modify the structure of the current source as well as of its control to adapt it to a LED/OLED technology where the electric representation would be a structure of common-cathode type or more generally a structure where the cathode of the LED would be connected to ground. The current source should then be placed between the anode of the LED and a high potential (VREF1 for example).

In the present embodiment, oscillating circuit OSC comprises a MOS transistor T5, for example, with a P channel, having a first power terminal coupled to source VREF1 of the first high reference potential and having its second power terminal coupled to a node Q supplying signal ST. Oscillating circuit OSC further comprises a capacitor C2 having its first electrode coupled to node Q and having its second electrode coupled to source GND of the low reference potential. Oscillating circuit OSC further comprises a MOS transistor T6, for example, with an N channel, having its first power terminal coupled to node Q and having its second power terminal coupled to source GND of the low reference potential. Oscillating circuit OSC further comprises a first inverter INV1 having its input coupled to node Q and having its output coupled to a node R. First inverter INV1 may comprise a MOS transistor T7, for example, with a P channel, series-connected with a MOS transistor T8, for example, with an N channel. The first power terminal of transistor T7 is coupled to source VREF1 of the first high reference potential and the second power terminal of transistor T7 is coupled to node R. The first power terminal of transistor T8 is coupled to node R and the second power terminal of transistor T8 is coupled to source GND of the low reference potential. The gates of transistors T7 and T8 are coupled to node Q. Oscillating circuit OSC further comprises a second inverter INV2 having its input coupled to node R and having its output coupled to a node S. Second inverter INV2 may comprise a MOS transistor T9, for example, with a P channel, series-connected with a MOS transistor T10, for example, with an N channel. The first power terminal of transistor T9 is coupled to source VREF1 of the first high reference potential and the second power terminal of transistor T9 is coupled to node S. The first power terminal of transistor T10 is coupled to node S and the second power terminal of transistor T10 is coupled to source GND of the low reference potential. The gates of transistors T9 and T10 are coupled to node S. Oscillating circuit OSC further comprises a MOS transistor T11, for example, with an N channel, having its first power terminal coupled to node R and having its second power terminal coupled to source GND of the low reference potential and a MOS transistor T12, for example, with an N channel, having its first power terminal coupled to node R and having its second power terminal coupled to source GND of the low reference potential. The gates of transistors T5, T6, T11, and T12 are coupled to node S.

According to an embodiment, source VREF1 of the first high reference potential is common to all the display circuits 12_{i,j} and the oscillating circuits OSC of display screen 10. According to an embodiment, source VREF2 of the second high reference potential is common to all the display circuits 12_{i,j} of display screen 10. According to another embodiment, display screen 10 comprises a plurality of sources VREF2 of the second high reference potential which are common to the display circuits 12_{i,j} emitting the same color. As an example, display screen 10 comprises a first source VREF2 of a second high reference potential for display circuits 12_{i,j} emitting red light, a second source VREF2 of the second high reference potential for display circuits 12_{i,j} emitting blue light, and a third source VREF2 of the second high reference potential for display circuits 12_{i,j} emitting green light. This particularly enables to vary the second high reference potentials differently according to the color of the light emitted by display circuits 12_{i,j}. According to an embodiment, sources VREF1 and VREF2 may be confounded.

The embodiment of control circuit 14_{i,j} shown in FIG. 3 has the advantage that the structure of comparison circuit COMP_{i,j} is particularly simple since it comprises a single MOS transistor.

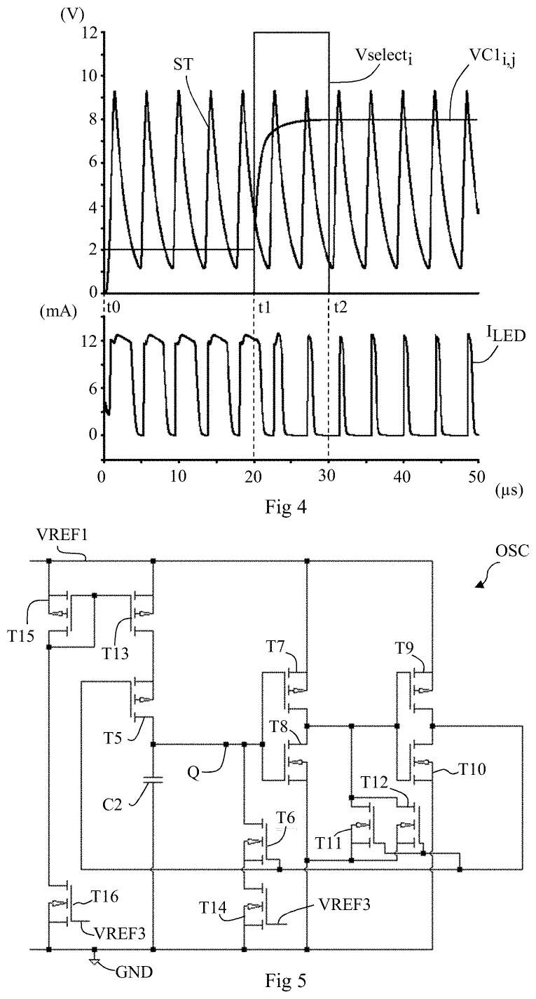

FIG. 4 shows a timing diagram obtained by simulations of voltages ST, Vselectᵢ, of voltage VC1_{i,j} across capacitor C1_{i,j} and of current I_{LED} flowing through light-emitting diode LED_{i,j} illustrating the operation of oscillating circuit OSC and of display circuit 12_{i,j} shown in FIG. 3. Times t0, t1, and t2 are successive. In the present example, the frequency of signal ST is 230 kHz and the display screen refreshment frequency is 20 ms. In the present example, signal Vselectᵢ is in the low state (0 V) from time t0 to time t1. MOS transistor T1 is thus non-conductive and voltage VC1_{i,j} across capacitor C1_{i,j} is constant at a first level (2 V) corresponding to the last stored level of signal Data_{i,j}. From time t1 to time t2, signal Vselectᵢ is in the high state (12 V). MOS transistor T1 is thus conductive and voltage VC1_{i,j} across capacitor C1_{i,j} varies to a second level (8 V) equal to Data_{i,j} supplied to display circuit 12_{i,j}. After time t2, signal Vselectᵢ is in the low state. MOS transistor T1 is thus non-conductive and voltage VC1_{i,j} across capacitor C1_{i,j} remains constant at the second level.

Current I_{LED} flowing through light-emitting diode LED_{i,j} has substantially the shape of a square signal, alternating between a first level at approximately 12 mA and a second level at approximately 0 mA, which is periodic from time t0 to time t1 and after time t2, with a duty cycle, equal to the ratio of the duration at the first level to the duration of the period, which depends on voltage VC1_{i,j}. The first intensity level of current I_{LED} is determined, in particular, by the level of the second high reference potential and the characteristics of transistor T4.

Oscillating circuit OSC supplies an oscillating and periodic signal ST, which preferably varies substantially monotonously over each period. An embodiment of oscillating circuit OSC is shown in FIG. 3. However, any type of oscillating circuit OSC capable of supplying a periodic oscillating signal ST, which preferably substantially monotonously varies over each period, may be used.

FIG. 5 shows another embodiment of oscillating circuit OSC.

The oscillating circuit OSC shown in FIG. 5 comprises all the elements of oscillating circuit OSC shown in FIG. 3 with the difference that transistor T5 is series-connected between a MOS transistor T13, for example, with a P channel, having its first power terminal coupled to source VREF1 of the first high reference potential and having its second power terminal coupled to the first power terminal of transistor T5 and with the difference that transistor T6 is series-assembled with a MOS transistor T14, for example, with an N channel, having its first power terminal coupled to the second power terminal of transistor T6, having its second power terminal coupled to source GND of the low reference potential, and having its gate coupled to a source VREF3 of a third high reference potential.

The oscillating circuit OSC shown in FIG. 5 further comprises a MOS transistor T15, for example, with a P channel, series-connected with a MOS transistor T16, for example, with an N channel. The first power terminal of transistor T15 is coupled to source VREF1 of the first high reference potential. The second power terminal of transistor T15 is coupled to the first power terminal of transistor T16 and the second power terminal of transistor T16 is coupled to source GND of the low reference potential. The gate of transistor T15 is coupled to the gate of transistor T13 and the gate of transistor T16 is coupled to source VREF3 of the third high reference potential.

The embodiment of the oscillating circuit OSC shown in FIG. 5 has the advantage of a better linearization of the charge and of the discharge of capacitor C2 with respect to the embodiment of the oscillating circuit OSC shown in FIG. 3.

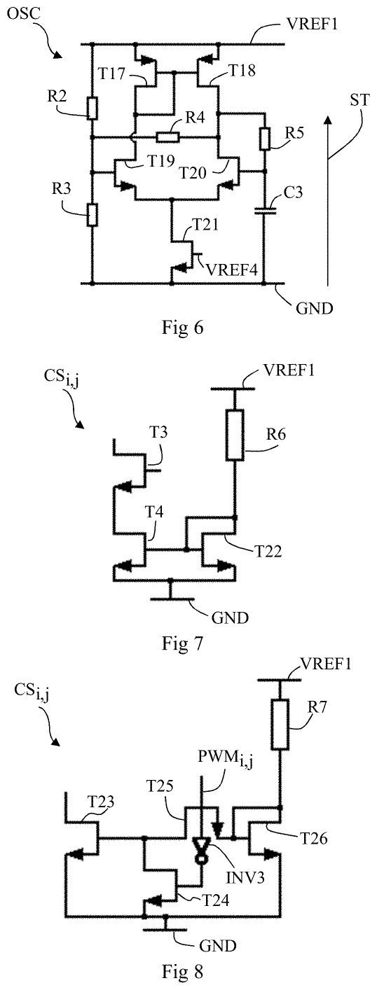

FIG. 6 shows another embodiment of oscillating circuit OSC.

The oscillating circuit OSC shown in FIG. 6 comprises two MOS transistors T17 and T18, for example, with a P channel, having their first power terminals coupled to source VREF1 of the first high reference potential and having their gates coupled to each other. The oscillating circuit OSC shown in FIG. 6 further comprises MOS transistors T19, T20, and T21, for example, with an N channel. The first power terminal of transistor T19 is coupled to the second power terminal of transistor T17 as well as to the gate of transistor T17. The first power terminal of transistor T20 is coupled to the second power terminal of transistor T18. The first power terminal of transistor T21 is coupled to the second power terminals of transistors T19 and T20. The second power terminal of transistor T21 is coupled to source GND of the low reference potential. The gate of transistor T21 is coupled to a source VREF4 of a fourth high reference potential. The oscillating circuit OSC shown in FIG. 6 further comprises four resistors R2, R3, R4, and R5. Resistor R2 is coupled between source VREF1 of the first high reference potential and the gate of transistor T19. Resistor R3 is coupled between the gate of transistor T19 and source GND of the low reference potential. Resistor R4 is coupled between the gate of transistor T19 and the first power terminal of transistor T20. Resistor R5 is coupled between the first power terminal of transistor T20 and the gate of transistor T20. The oscillating circuit OSC shown in FIG. 6 further comprises a capacitor C3 having its first electrode coupled to the gate of transistor T20 and having its second electrode coupled to source GND of the low reference potential. Oscillating signal ST for example corresponds to the voltage across the assembly formed by resistor R5 and capacitor C3. An advantage of the oscillating circuit OSC shown in FIG. 6 is that the switching times may be controlled with an increased accuracy.

Controllable current source CS_{i,j} supplies, when it is activated, a substantially constant current which powers light-emitting diode LED_{i,j}. An embodiment of controllable current source CS_{i,j} is shown in FIG. 3. However, any type of control-lable current source CS_{i,j} and capable of supplying a substantially constant current which powers light-emitting diode LED_{i,j} may be used.

FIG. 7 shows another embodiment of controllable current source CS_{i,j}.

The controllable current source CS_{i,j} shown in FIG. 7 comprises all the elements of the controllable current source CS_{i,j} shown in FIG. 3 with the difference that the gate of transistor T4 is coupled to the gate of a MOS transistor T22, for example with an N channel. The controllable current source CS_{i,j} shown in FIG. 7 further comprises a resistor R6 having a terminal coupled to source VREF1 of the first high reference potential and having its second terminal coupled to the first power terminal of transistor T22. The second power terminal of transistor T22 is coupled to source GND of the low reference potential. The first power terminal of transistor T22 is further coupled to the gate of transistor T22. An advantage of the current source shown in FIG. 7 is that it does not require using source VREF2 of the second high reference potential. It can thus easily be formed at the level of display circuit 12_{i,j}.

FIG. 8 shows another embodiment of controllable current source CS_{i,j}.

The controllable current source CS_{i,j} shown in FIG. 8 comprises MOS transistors T23, T24, T25, and T26, for example, with an N channel. The first power terminal of transistor T23 is coupled to the cathode of light-emitting diode LED_{i,j}, not shown. The second power terminal of transistor T23 is coupled to source GND of the low reference potential. The first power terminal of transistor T24 is coupled to the gate of transistor T23. The second power terminal of transistor T24 is coupled to source GND of the low reference potential. The first power terminal of transistor T25 is coupled to the gate of transistor T23. The gate of transistor T25 receives signal PWM_{i,j}. The controllable current source CS_{i,j} shown in FIG. 8 further comprises a resistor R7 having its terminal coupled to source VREF1 of the first high reference potential and having its second terminal coupled to the first power terminal of transistor T26. The second power terminal of transistor T26 is coupled to source GND of the low reference potential. The first power terminal of transistor T26 is further coupled to the gate of transistor T26. The gate of transistor T26 is coupled to the second power terminal of transistor T25. The controllable current source CS_{i,j} shown in FIG. 8 further comprises an inverter INV3 having its input coupled to the gate of transistor T25 and having its output coupled to the gate of transistor T24.

Specific embodiments have been described. Various alterations and modifications will readily occur to those skilled in the art. Further, various embodiments with various variations have been described hereabove. It should be noted that various elements of these embodiments and variations may be combined. As an example, the embodiment of controllable current source CS_{i,j} shown in FIG. 7 or 8 may be implemented with the oscillating circuit OSC shown in FIG. 5 or 6.

1. A display screen comprising display circuits, each display circuit comprising a light-emitting diode, a controllable current source powering the light-emitting diode, and a control circuit capable of supplying a pulse-width modulated signal for controlling the current source from a periodic signal, the display screen further comprising first electrodes coupled to the control circuits, a circuit for supplying a selection signal successively on each first electrode, and an oscillating circuit or oscillating circuits (OSC) capable of supplying the periodic signals, the periodic signals being non-synchronous with the display circuit selection signals.

2. The display screen of claim 1, comprising at least two oscillating circuits capable of supplying the periodic signals.

3. The display screen of claim 2, wherein the at least two oscillating circuits are capable of supplying the non-synchronous periodic signals.

4. The display screen of claim 2, wherein each of said at least two oscillating circuits is coupled to at least two of said control circuits.

5. The display screen of claim 2, wherein each of said at least two oscillating circuits is coupled to at least ten of said control circuits.

6. The display screen of any of claim 2, comprising at least one thousand display circuits and wherein each of said at least two oscillating circuits is coupled to less than one hundred of said control circuits.

7. The display screen of claim 1, further comprising second electrodes coupled to the control circuits and a circuit for supplying data signals on the second electrodes and wherein the control circuit of each display circuit comprises a circuit for storing the data signal received by the control circuit and a circuit for comparing the data signal and the periodic signal capable of supplying the pulse-width modulated control signal.

8. The display screen of claim 1, wherein the frequency of each periodic signal is greater than twice the frequency of the selection signal on one of the first electrodes.

9. The display screen of claim 1, wherein the frequency of each periodic signal is greater than ten times the frequency of the selection signal on one of the first electrodes.

10. The display screen of claim 1, wherein the frequency of each periodic signal is smaller than 1 MHz.
